(19) United States
(12) Patent Application Publication
(10) Pub. No.: US 2009/0311576 A1
(43) Pub. Date: Dec. 17, 2009

(54) DIRECT METHANOL TYPE FUEL CELL STACK AND DIRECT METHANOL TYPE FUEL CELL SYSTEM

(75) Inventors: Young-Seung NA, Suwon-si (KR); Kyoung-Hwan CHOI, Suwon-si (KR); Ji-Rae KIM, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG SDI CO., LTD., Suwon-si (KR)

(21) Appl. No.: 12/465,432

(22) Filed: May 13, 2009

(30) Foreign Application Priority Data
Jun. 17, 2008 (KR) 10-2008-0056815

(51) Int. Cl. H01M 2/02

(52) U.S. Cl. 429/34

(57) ABSTRACT

A direct methanol type fuel cell stack and a direct methanol type fuel cell system using the same are discussed. The fuel cell stack may be configured to allow a concentration gradient of a mixed fuel in which fuel and water are not properly mixed to be uniform without increasing the volume of the fuel cell stack. The fuel cell stack may include at least one cell having an anode, a cathode, an electrolyte separating the anode and the cathode and a mixer coupled to the anode. The mixer may be configured to mix fuel and water and achieve a uniform concentration of the mixed fuel supplied to the anode.

### CROSS-REFERENCE TO RELATED APPLICATIONS

This application claims priority to and the benefit of Korean Patent Application No. 10-2008-0056815, filed on Jun. 17, 2008, in the Korean Intellectual Property Office, which is hereby incorporated by reference in its entirety.

### BACKGROUND

1. Field of the Invention

The present invention relates to a direct methanol type fuel cell stack configured to provide a uniform concentration gradient of fuel and water without increasing the volume of the fuel cell stack. The present invention also relates to a direct methanol type fuel cell system using the same.

2. Discussion of Related Art

A fuel cell system directly converts chemical energy produced from various fuels, such as natural gas, liquefied natural gas, kerosene, coal, naphtha, methanol, hydride and waste gas, into electric energy. The fuel cell may serve as a next-generation “clean” system. Some types of fuel cells include a molten carbonate fuel cell (“MCFC”), a solid oxide fuel cell (“SOFC”), a polymer electrolyte fuel cell (“PEFC”), a proton exchange membrane fuel cell (“PEMFC”), a phosphoric acid fuel cell (“PAFC”), an alkaline fuel cell (“AFC”) and the like, depending on electrolytes used in the fuel cell.

Since PEFCs or PEMFCs use an ion-exchange membrane made of a solid polymer as an electrolyte, the PEMFC has no corrosion or evaporation caused by the electrolyte and obtains a high current density per unit area. Further, since the PEMFC has a higher power characteristic and a lower operation temperature than other fuel cells, the PEMFC is used for portable power sources that supply power to small-sized electronic devices such as notebook computers. Furthermore, studies have been actively conducted to develop the PEMFC as a power source that supplies power to automobiles, yachts or the like, or a power source that supplies power to houses, public buildings or the like.

### SUMMARY OF CERTAIN INVENTIVE ASPECTS

Accordingly, it is an object of the present disclosure to provide a direct methanol type fuel cell stack configured to allow a concentration gradient of a mixed fuel in which fuel and water are not properly mixed to be uniform while not increasing the volume of the fuel cell stack.

In one aspect a direct methanol type fuel cell stack comprises at least one cell having an anode, a cathode and an electrolyte separating the anode and the cathode and a built-in mixer coupled to the anode of the at least one cell. In some embodiments the built-in mixer is configured to mix fuel and water to a uniform concentration and wherein the mixer is configured to supply the uniform concentration to the anode and mixing fuel and water contained in a mixed fuel so that the concentration of the mixed fuel supplied to the anode is uniform.

In some embodiments the fuel cell stack further comprises at least one separator disposed between a plurality of cells to form and forming a laminated assembly together with the plurality of cells. In some embodiments the built-in mixer is positioned either installed at an entrance of an anode inlet manifold or inside the entrance of the anode inlet manifold, wherein the anode inlet manifold is formed in a laminated direction of the plurality of cells and separators or inside the entrance of the anode inlet manifold. In some embodiments the built-in mixer has tube-shaped spiral channels or intersecting channels.

In another aspect a direct methanol type fuel cell system comprises a fuel cell stack including at least one cell having an anode, a cathode and an electrolyte separating the anode and the cathode, and generating the cell configured to generate electricity through an electrical chemical electrochemical reaction of a fuel and an oxidizer, a raw material tank configured to store storing a raw material fuel, a first mixer configured to receive receiving non-reaction fuel and water discharged from the fuel cell stack and configured to receive receiving the raw material fuel supplied from the raw material tank and a second mixer installed positioned in an anode inlet of the fuel cell stack, the second mixer configured to mix and mixing the raw material fuel supplied from the first mixer, the non-reaction fuel and water.

In some embodiments the fuel cell stack further comprises at least one separator disposed between a plurality of cells to form and forming a laminated assembly together with the plurality of cells. In some embodiments the at least one separator forms a laminated assembly together with the at least one cell. In some embodiments the second mixer is installed positioned in an anode inlet manifold formed in a laminated direction of the laminated assembly. In some embodiments the second mixer has tube-shaped spiral channels or intersecting channels.

In another aspect a direct methanol type fuel cell system comprises a fuel cell stack including at least one cell having an anode, a cathode and an electrolyte separating the anode and the cathode, wherein the at least one cell is configured to generate and generating electricity through an electrical chemical reaction of a fuel and an oxidizer, a raw material tank configured to store storing a raw material fuel, a first mixer configured to receive receiving non-reaction fuel and water discharged from the fuel cell stack and configured to receive receiving the raw material fuel supplied from the raw material tank, a pump configured to transfer transferring the raw material fuel and the non-reaction fuel and water from the first mixer to the fuel cell stack and a second mixer installed positioned between the pump and the fuel cell stack, and mixing the second mixer configured to mix the raw material fuel supplied from the first mixer, the non-reaction fuel and water.

In some embodiments the fuel cell stack further comprises comprising at least one separator disposed between a plurality of cells to form and forming a laminated assembly together with the plurality of cells. In some embodiments the second mixer has tube-shaped spiral channels or intersecting channels.

In another aspect a direct methanol type fuel cell stack comprises a fuel cell having an anode, a cathode and an electrolyte separating the anode and the cathode and means for mixing fuel and water coupled to the anode of the fuel cell, wherein the means for mixing is configured to supply a uniform concentration of fuel and water to the anode.

In some embodiments the means for mixing comprises a tube-shaped spiral channel. In some embodiments the means for mixing comprises a plurality of intersecting channels. In some embodiments the means for mixing comprises an active mixer. In some embodiments the means for mixing comprises a chaotic mixer.

### BRIEF DESCRIPTION OF THE DRAWINGS

An apparatus according to some of the described embodiments and the illustrated figures can have several aspects, no single one of which is solely responsible for the desirable attributes of the apparatus. After considering this discussion one of ordinary skill will understand how to make and use a direct methanol type fuel cell stack and system using the same.

FIG. 1 is a block diagram of one embodiment of a direct methanol type fuel cell system.

FIG. 2 is schematic view showing an embodiment of a direct methanol type fuel cell stack.

FIG. 3 is a cross-sectional view showing another embodiment of the direct methanol type fuel cell stack.

FIG. 4A is a cross-sectional view showing an embodiment of a second mixer.

FIG. 4B is a cross-sectional view showing another embodiment of the second mixer.

FIG. 5 is a graph showing power and cell deviation of a fuel cell system.

FIG. 6 is a graph showing changes in power of the fuel cell system.

FIG. 7 is a graph showing changes in power of the fuel cell system.

### DETAILED DESCRIPTION OF CERTAIN EMBODIMENTS

Hereinafter, preferable embodiments easily carried out by those skilled in the art to which the present invention belongs will be described with reference to the accompanying drawings.

In the following detailed description, high absorption and high absorbent does not substantially involve absorption of energy and is defined by a movement of system by means of interaction of materials. In particular, there may be a movement of gas and solid, however, the description is limited to a movement of liquid. Also, the thickness or size of each layer shown in the drawings can be exaggerated for convenience or clarity of explanation. Detailed descriptions of well-known functions or constitutions will be omitted so as not to obscure the described subject matter.

A direct methanol type fuel cell may use an ion-exchange membrane made of a solid polymer as an electrolyte. The direct methanol type fuel cell is typically operated at a temperature below 100° C. using a liquid fuel such as methanol, instead of a fuel reformer. For this reason, the direct methanol type fuel cell is more suitable as a power source for a small-sized electronic device or a power source for a portable electronic device.

The direct methanol fuel cell may be manufactured in two types, i.e., a laminated stack and a flat plate stack. The laminated stack has a structure in which a plurality of cells are laminated to one another by interposing separators between a plurality of cells. The flat plate stack has a structure in which a plurality of cells are spread and arranged on the same plane. The respective cells are electrically coupled to one another through separate wires.

Direct methanol type fuel cells may use a “mixed fuel” of fuel and water. This is because a portion of fuel supplied to an anode does not react in the anode. Instead it diffuses into a cathode by passing through an electrolyte membrane. For this reason, the mixed fuel may be used to reduce a diffusion amount by lowering the concentration of fuel. The fuel diffused into the cathode performs an oxidation reaction in the cathode. The oxidation reaction causes a reverse voltage in a fuel cell stack, thereby decreasing performance of the fuel cell stack and interrupting normal operation. When methanol is used as the fuel, the direct methanol type fuel cell is configured so that a methanol aqueous solution having a concentration of about 1 mol can be supplied to the anode of the fuel cell stack.

Meanwhile, if a previously mixed fuel is used with a concentration of about 1 mol. the volume of a tank storing the mixed fuel is increased and it is difficult to control the concentration of the mixed fuel when recycling both water and non-reaction fuel discharged from the fuel cell stack. Here, the “water” refers to a by-product of an electrical chemical reaction of a fuel cell. The non-reaction fuel refers to fuel not used in the electrical chemical reaction, but discharged from the fuel cell stack although being supplied to the fuel cell stack.

Direct methanol type fuel cell systems may have a recycling system to enhance system efficiency. The recycling system recycles the water and non-reaction fuel discharged from the fuel cell stack. The recycling system may include a mixture tank configured to store water and non-reaction fuel. The mixture tank may be coupled to a raw material tank so that fluid can flow into the raw material tank. The mixture tank may also be coupled to a water tank so that a fluid can flow into the water tank. Generally, the raw material tank is configured to store a high-concentration fuel having a higher concentration than that of a mixed fuel supplied to the fuel cell stack. The raw material tank may also be configured to supply the high-concentration fuel to the mixture tank.

When the direct methanol type fuel cell system is used as a power source for a small-sized electronic device such as a notebook computer, it should satisfy a required performance and a required volume. The mixture tank may be used to satisfy the required performance and the number of components should be decreased or their volume should be reduced to satisfy the required volume. In the case of a power source for a small-sized electronic device, a mixture tank may be installed to enhance performance, but there is a limit in increasing the size of the mixture tank for the purpose of miniaturization.

However, if the mixture tank is not large enough, a mixed fuel is periodically supplied to the fuel cell stack. If the mixed fuel is supplied intermittently, then the non-reaction fuel and water will not be uniformly collected from the fuel cell stack. The fluctuation may adversely affect performance of the fuel cell stack due to the supply of a mixed fuel which is not properly mixed. This may also adversely influence a long-term stable operation of the fuel cell system.

FIG. 1 is a schematic block diagram of one embodiment of a direct methanol type fuel cell system. The fuel cell system includes a fuel cell stack 10, a mixture tank 30 (hereinafter, referred to as a “first mixer”), and a pump 40 (hereinafter, referred to as an “injection pump”). The fuel cell stack 10 includes an anode 12, a cathode 14, an electrolyte 16 separating the anode 12 and the cathode 14, and a mixer 18 (hereinafter, referred to as a “second mixer or built-in mixer”) coupled to the anode 12. The first mixer 30 receives non-reaction fuel and water supplied from the fuel cell stack 10 and receives raw material fuel supplied from the raw material tank 36. The injection pump 40 transfers the raw material fuel, non-reaction fuel and water from the first mixer 30 to the fuel cell stack 10.

The fuel cell system includes a fuel cell stack 10 of direct methanol type fuel cells, in which a liquid fuel is directly used in an electrical chemical reaction. The anode 12 includes a first catalyst layer and a first current collector, and may further include channels for fuel flowing provided to the first current collector so as to supply a mixed fuel. Similarly, the cathode 14 may include a second catalyst layer and a second current collector, and may further include channels for oxidizer flowing provided to the second current collector so as to supply an oxidizer. The electrolyte 16 may include an ion-exchange membrane made of a solid polymer.

In the direct methanol type fuel cell stack 10 using a solid polymer membrane as the electrolyte 16, the mixed fuel is prepared by mixing fuel and water so that the concentration of the fuel is lowered. This may result in fuel crossover. Fuel crossover is a phenomenon that occurs when the fuel is not reacted in the anode 12 but instead moves to the cathode 14 by passing through the electrolyte 16. When a methanol aqueous solution is used as the fuel, the mixed fuel may be a methanol aqueous solution of about 1 mol.

The first mixer 30 is configured to enhance efficiency of the system. However, the first mixer 30 may be minimized to minimize the volume of the system. In a minimized volume the raw material fuel supplied to the first mixer 30 through a fuel pump 38 from the raw material tank 36 cannot be properly mixed with the non-reaction fuel and water supplied from the fuel cell stack 10.

The first mixer 30 may include a one-port to four-port connection tube. A first port is connected to the anode 12 of the fuel cell stack 10 so that the non-reaction fuel can flow into the anode 12 of the fuel cell stack 10. A second port is connected to the cathode 14 of the fuel cell stack 10 so water can flow into the cathode 14 of the fuel cell stack 10. A third port may be connected to the raw material tank 36 so that the raw material fuel can flow into the raw material tank 36. A fourth port may be configured to supply the raw material fuel, non-reaction fuel and water to the anode 12 of the fuel cell stack 10. When the non-reaction fuel and water are supplied through one port in the fuel cell stack 10, it will be apparent that the first mixer 30 may include a three-port connection tube.

The second mixer 18 may be a built-in mixer integrally coupled to the anode 12 of the fuel cell stack 10. By using the second mixer 18, fuel and water in the mixed fuel supplied from the outside can be substantially mixed without increasing the volume of the fuel cell stack 10.

The second mixer 18 is useful when the non-reaction fuel and water were not previously properly mixed before being supplied to the fuel cell stack 10. For example, desirable features of the direct methanol type fuel cell system used as a power source of a portable electronic device may include a long lifetime and a small volume. A recycling system may be used to improve efficiency and long-term operation of the direct methanol type fuel cell system, but the volume of the recycling system should be small. However, if the size of the first mixer 30 is too small, the mixed fuel, in which the fuel and water are not properly mixed, may be supplied to the fuel cell stack 10. The second mixer 18 may thus be installed in an anode inlet of the fuel cell stack 10 so that the mixed fuel, in which the raw material fuel, non-reaction fuel and water are well mixed, is supplied to the fuel cell stack 10. Accordingly, the power of the fuel cell stack can be stabilized, and the lifetime of the direct methanol type fuel cell system can be increased.

The second mixer 18 may be built in the anode inlet of the fuel cell stack 10. However, the second mixer 18 may also be installed between the first mixer 30 and the anode inlet of the fuel cell stack 10. More specifically, the second mixer 18 may be installed between the injection pump 40 and the anode inlet of the fuel cell stack 10. In this case, a small volume of the second mixer 18 is preferred so that the volume of the fuel cell system is not increased. Since the second mixer 18 has a small size with which it can be inserted into the anode inlet of the fuel cell stack 10, the second mixer 18 may be installed as a portion of a tube connecting the injection pump 40 and the anode inlet of the fuel cell stack 10 or installed in the tube.

The fuel cell system of this embodiment may include a first heat exchanger 31 configured to collect non-reaction fuel coming out from the anode 12 of the fuel cell stack 10, and a first gas-liquid separator 32 exhausting a gas such as carbon dioxide, coming out from the anode 12 of the fuel cell stack 10. The fuel cell system may include a second heat exchanger 33 configured to collect fuel crossover with water coming out from the cathode 14 of the fuel cell stack 10, and a second gas-liquid separator 34 exhausting unnecessary gas coming out from the cathode 14 of the fuel cell stack 10. In addition, the fuel cell system may include an air pump 42 supplying air to the cathode 14. Here, the air containing oxygen is an example of an oxidizer.

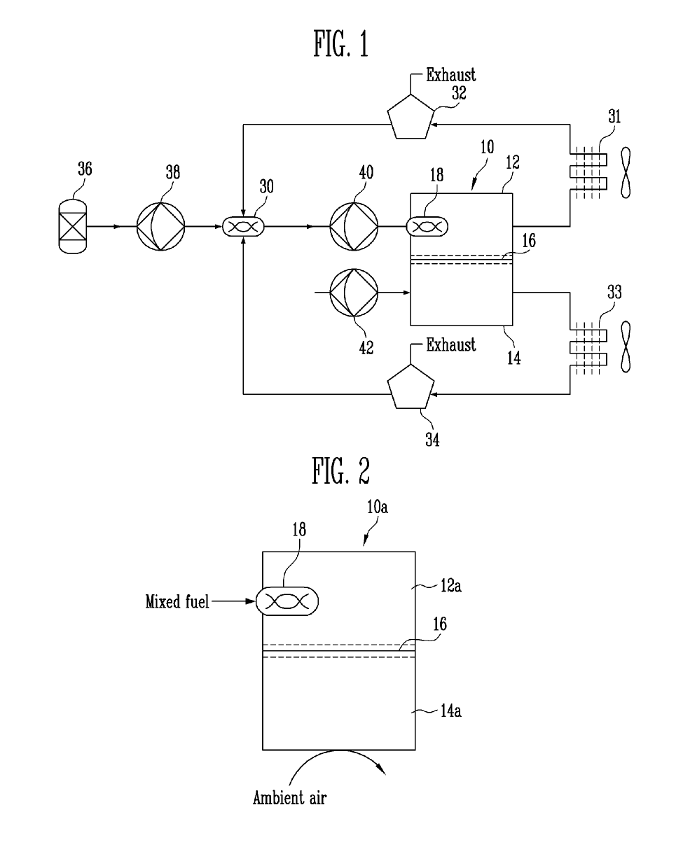

FIG. 2 is schematic view showing an embodiment of a direct methanol type fuel cell stack. The fuel cell stack 10a includes an anode 12a, a cathode 14a, an electrolyte 16 separating the anode 12a from the cathode 14a, and a built-in mixer 18 coupled to the anode 12a. The fuel cell stack 10a of this embodiment includes a passive direct methanol type fuel cell stack that produces electricity using a mixed fuel supplied to the anode 12a and a circulation air supplied to the cathode 14a.

The anode 12a may include a first catalyst layer and a first current collector. The anode 12a may further include a channel installed in the first current collector to supply the mixed fuel and a manifold. The cathode 14a may include a second catalyst layer and a second current collector. The cathode 14a may further include another channel installed in the second current collector to flow the circulation air. The channel may include a through-hole passing through the second current collector. In the event that the fuel cell stack of FIG. 2 is applied to the fuel cell system shown in FIG. 1, the second heat exchanger 33, the second gas-liquid separator 34 and the air pump 42 may be omitted.

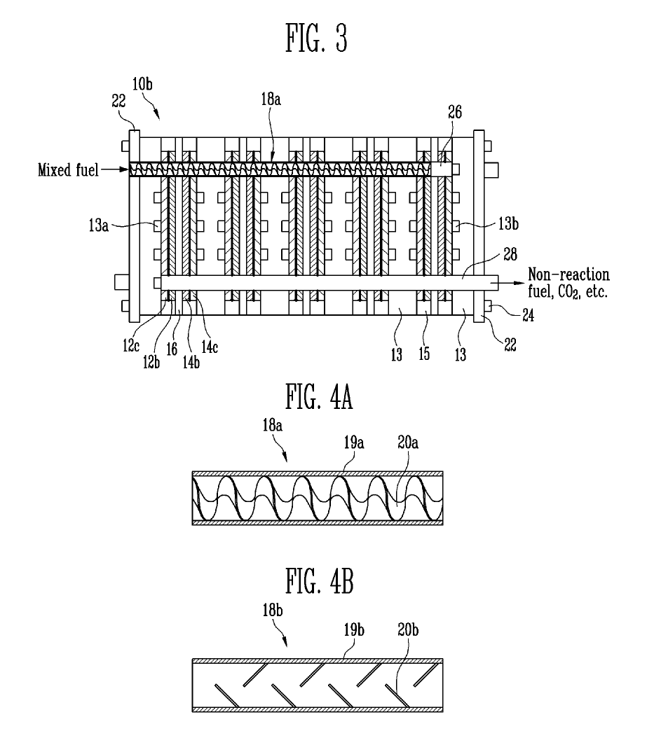

FIG. 3 is a cross-sectional view showing another embodiment of a direct methanol type fuel cell stack. The fuel cell stack 10b includes an anode 12a, a cathode 14a, an electrolyte 16 and a built-in mixer 18a. The anode 12a includes an anode catalyst layer 12b and a first gas diffusion layer 12c, and the cathode 14a includes a cathode catalyst layer 14b and a second gas diffusion layer 14c. The electrolyte 16 separates the anode 12a and the cathode 14a, and the built-in mixer 18a is inserted into an anode inlet manifold 26. A laminated assembly of the anode 12a, the electrolyte 16 and the cathode 14a constitutes a cell, and is referred to as a membrane electrode assembly (MEA).

The fuel cell stack 10b also includes also includes separators 13, gaskets 15, a pair of end plates 22 and fastening members 24. The separators 13 are referred to as separating plates and positioned between cells to form a laminated assembly with the cells. The separator 13 includes a plurality of channels 13a for fuel flowing, which supply a mixed fuel to anodes of the respective cells, and/or a plurality of channels 13b for oxidizer flowing, which supply an oxidizer to cathodes of the respective cells. The gaskets 15 seal the respective cells so that the mixed fuel and oxidizer supplied to the respective cells are not leaked out, and external air or impurity is not penetrated into the respective cells. The pair of end plates 22 are disposed at both ends of the laminated assembly of the cells and the separators 13, respectively, and joined with each other by the fastening members 24 to support the laminated assembly in a laminated direction.

The fuel cell stack 10b in FIG. 3 may be substituted for the fuel cell stack 10a in the direct methanol type fuel cell system illustrated in FIG. 1. In some embodiments the fuel cell system using the fuel cell stack 10b may further include a water tank configured to store previously prepared water, such as pure water. In some embodiments, the water tank is connected to the first mixer 30 in FIG. 1 so that a fluid can flow into the first mixer 30, and supply water to the first mixer 30 depending on an occasion. The water tank may be connected to the first mixer 30 through the second gas-liquid separator 34.

Hereinafter, an operation of the direct methanol type fuel cell system employing the fuel cell stack 10b will be briefly described with reference to FIGS. 1 and 3. In the following description, it is assumed that the fuel cell system of this embodiment has a water tank for convenience of illustration.

First, the first mixer 30 receives raw material fuel supplied from the raw material tank 36 and receives water supplied from the water tank (not shown). As mentioned above, the capacity of the first mixer 30 is designed to be small for the purpose of miniaturization of the fuel cell system. Therefore, the raw material fuel and water that flow into the first mixer 30 exist in the state that they are not properly mixed. The injection pump 40 transfers the mixed fuel, in which the raw material fuel and water are not properly mixed, to the fuel cell stack 10b. The raw material fuel and water in the mixed fuel that flows into the fuel cell stack 10b are more effectively mixed by passing through the second mixer 18a installed in the anode inlet manifold 26.

The mixed fuel in which the raw material fuel and water are mixed better than in the first mixer 30 may be supplied to each of the cells in the fuel cell stack 10b. The mixed fuel supplied to each of the cells may be more uniformly diffused into the anode catalyst layer 12b of each of the cells and oxidized in the anode catalyst 12b.

The oxidation reaction of methanol fuel in the anode may be expressed by the following reaction formula:

Anode electrode: CH₃OH+H₂O→CO₂+6H⁺+6e⁻ [Reaction formula 1]

In case of a methanol aqueous solution, the mixed fuel supplied to the anode is changed into protons, carbon dioxide and electrons. In some embodiments protons are moved to the cathode catalyst layer 14b by passing through the electrolyte 16, and the moved protons are combined with an oxidizer, e.g., oxygen in the air in the cathode catalyst 14b to be deoxidized. In some embodiments electrons move from the anode to the cathode through an external load or external wire electrically coupling the anode and the cathode to generate electricity.

The reduction reaction of protons in the cathode may be expressed by the following reduction formula:

Cathode electrode: 6H⁺6e⁻+3/2O₂→3H₂O [Reaction formula 2]

In some embodiments a portion of the mixed fuel supplied to the fuel cell stack 10b does not participate in an electrical chemical reaction, but is instead discharged through an anode outlet manifold 28. In some embodiments a portion of the mixed fuel does not participate in the electrical chemical reaction and moves to the cathode through the electrolyte 16. Then, the other portion of the mixed fuel is discharged together with water produced in the cathode through a cathode outlet manifold (not shown). In some embodiments the non-reaction fuel and water discharged from the fuel cell stack 10b are circulated into the first mixer 30 through a heat exchanger and a gas-liquid separator.

In normal operation of the fuel cell system, an amount of non-reaction fuel and water that almost uniformly flow into the first mixer 30 is considerably greater than that of a first raw material fuel intermittently supplied to the first mixer 30. For example, the non-reaction fuel and water may be supplied to the first mixer 30 at a flow rate of about 10 cc per minute. The raw material fuel is a high-concentration fuel having a relatively higher concentration than that of fuel to be supplied to the fuel cell stack 10b, such as a pure methanol in which water is not mixed or a methanol aqueous solution of over 6 mols. For this reason, the raw material fuel may be intermittently supplied to the first mixer 30 at a flow rate of about 0.1 cc per second.

That is, in the direct methanol type fuel cell system used as a small-sized power source (such as a power source of a portable electronic device) the capacity of the first mixer 30 is small. Further, the mixed fuel, in which the non-reaction fuel and water are not properly mixed, may be supplied to the fuel cell stack 10b due to a capacity difference between the non-reaction fuel and water and the raw material fuel, and a method of intermittently supplying the raw material fuel. That is, in the event that it is difficult to provide a sufficient mixture space for mixing the non-reaction fuel and water and a sufficient time for mixing the non-reaction fuel and water in the mixture space, the mixed fuel, in which the non-reaction fuel and water are not properly mixed, is supplied to the fuel cell stack 10b through the injection pump 40 in the fuel cell system.

In some embodiments the raw material fuel, non-reaction fuel and water in the mixed fuel supplied to the fuel cell stack 10b are well mixed by the second mixer 18a, so that the power of the fuel cell stack 10b can be stabilized, and the fuel cell system can be stably operated for a long period of time.

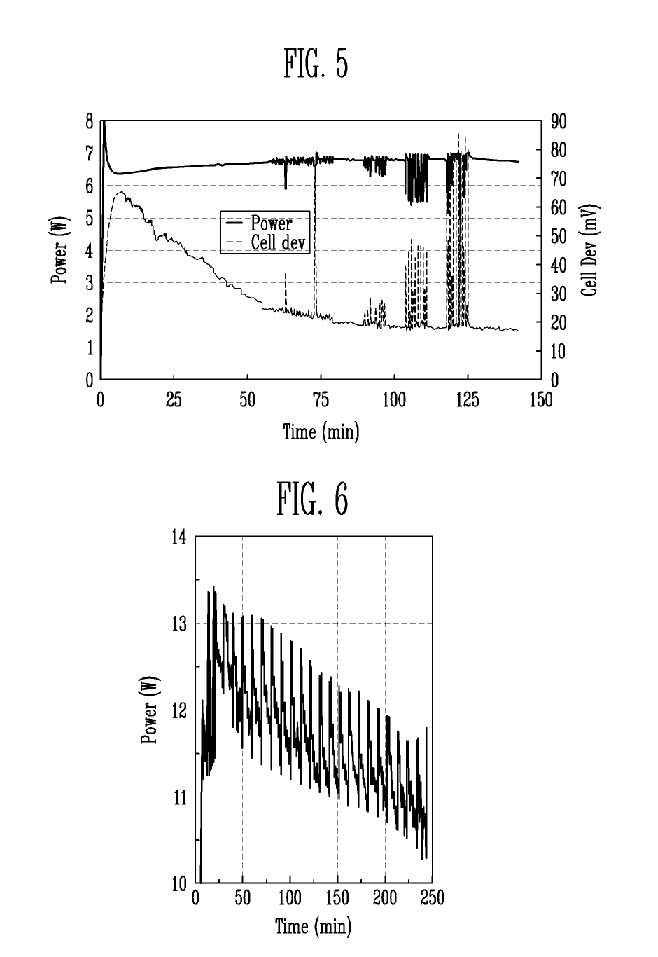

FIG. 4A is a cross-sectional view showing an embodiment of a second mixer. The second mixer 18a includes a frame member 19a having a tube shape and short spiral-shaped barrier walls 20a alternately arranged in left and right spiral directions so that a flow is expanded and then compressed in an internal space of the frame member 19a. By using the second mixer 18a, non-reaction fuel and water in the mixed fuel, in which the non-reaction fuel and water are not properly mixed, are effectively mixed, so that the concentration gradient of the mixed fuel supplied to the fuel cell stack can be uniform.

The frame member 19a may be configured with a shape for insertion into the anode inlet manifold 26 of the fuel cell stack 10b shown in FIG. 3. The frame member 19a and the barrier walls 20a are made of a material that is not reacted to fuel such as methanol. The frame member 19a and the barrier walls 20a have an insulation property so that a short circuit is not formed between the cells when inserted into the anode inlet manifold 26.

FIG. 4B is a cross-sectional view showing another embodiment of the second mixer. The second mixer 18b includes a frame member 19b having a tube shape, and protrusion-shaped barrier walls 20b alternately arranged to be inclined at about 45 degrees from an advancing direction of a flow on surfaces opposite to each other so that the flow is divided, rearranged and combined in an internal space of the frame member 19b. By using the second mixer 18b, non-reaction fuel and water in the mixed fuel, in which the non-reaction fuel and water are not properly mixed, are effectively mixed, so that the concentration gradient of the mixed fuel supplied to the fuel cell stack can be uniform. The frame member 19b is made of the same material as the aforementioned frame member 19a.

For reference, the second mixer 18b of this embodiment may be installed so that the mixed fuel is flowed into from the right of the frame member 19b and flowed out to the left of the frame member 19b when being seen from the front of the frame member 19b shown in FIG. 4A.

FIG. 5 is a graph showing power and cell deviation of a fuel cell system according to a comparative embodiment. In the fuel cell system of this comparative embodiment, a change in voltage of each cell was measured by alternately injecting a methanol aqueous solution of 1 mol as a low-concentration fuel and a methanol aqueous solution of 6 mols as a high-concentration fuel. Stack power (Power) and cell deviation (Cell dev) were calculated based on the result measured for a predetermined time.

As shown in FIG. 5, the fuel cell stack illustrates a cell deviation of over 70 mV after about 70 minutes from the start of the fuel cell stack. The cell deviation was also gradually increased over approximately 120 minutes. It can be seen that the power of the fuel cell stack fluctuated rapidly while the cell deviation increased during the approximately 120 minutes.

FIG. 6 is a graph showing changes in power of the fuel cell system according to the comparative embodiment of FIG. 5.

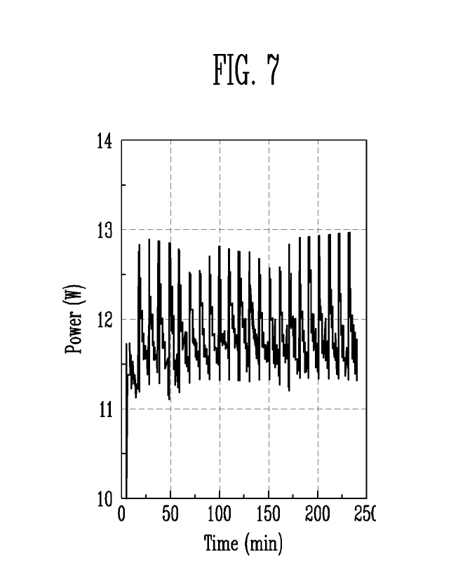

FIG. 7 is a graph showing changes in power of the fuel cell system according to one embodiment of the present disclosure. The fuel cell system shown in FIG. 1 was used as the fuel cell system graphed in FIG. 7. The fuel cell system of the comparative embodiment of FIG. 6 was prepared with the same configuration as the fuel cell system shown in FIG. 1, except for an anode inlet of a fuel cell stack or a second mixer installed in a front end of the anode inlet. In the fuel cell system of the illustrated comparative embodiment in FIG. 6, stack performance continuously decreased over time. On the other hand, in the fuel cell system illustrated in FIG. 7, stack performance was well maintained over time.

In some embodiments the second mixer has been referred to as a chaotic mixer. However, it will be understood by those skilled in the art that the second mixer employed in the fuel cell stack and fuel cell system can be easily implemented as an active mixer as well as or in addition to a chaotic mixer. In the case of the active mixer, the second mixer may include a piezoelectric element.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof

What is claimed is:

1. A direct methanol type fuel cell stack, comprising:
at least one cell having an anode, a cathode and an electrolyte separating the anode and the cathode; and
a built-in mixer coupled to the anode of the at least one cell,
wherein the built-in mixer is configured to mix fuel and water to a uniform concentration and wherein the mixer is configured to supply the uniform concentration to the anode.

2. The fuel cell stack of claim 1, further comprising at least one separator disposed between a plurality of cells to form a laminated assembly.

3. The fuel cell stack of claim 2, wherein the built-in mixer is positioned either at an entrance of an anode inlet manifold or inside the entrance of the anode inlet manifold, wherein the anode inlet manifold is formed in a laminated direction of the plurality of cells and separators.

4. The fuel cell stack of claim 3, wherein the built-in mixer has tube-shaped spiral channels or intersecting channels.

5. The fuel cell stack of claim 1, wherein the built-in mixer has tube-shaped spiral channels or intersecting channels.

6. A direct methanol type fuel cell system, comprising:
a fuel cell stack including at least one cell having an anode, a cathode and an electrolyte separating the anode and the cathode, the cell configured to generate electricity through an electro-chemical reaction of a fuel and an oxidizer;
a raw material tank configured to store a raw material fuel;
a first mixer configured to receive non-reaction fuel and water from the fuel cell stack and configured to receive the raw material fuel from the raw material tank; and
a second mixer positioned in an anode inlet of the fuel cell stack, the second mixer configured to mix the raw material fuel from the first mixer, the non-reaction fuel and water.

7. The fuel cell system of claim 6, wherein the fuel cell stack further comprises at least one separator disposed between a plurality of cells to form a laminated assembly together with the plurality of cells.

8. The fuel cell system of claim 7, wherein the at least one separator forms a laminated assembly together with the at least one cell.

9. The fuel cell system of claim 8, wherein the second mixer is positioned in an anode inlet manifold formed in a laminated direction of the laminated assembly.

10. The fuel cell system of claim 9, wherein the second mixer has tube-shaped spiral channels or intersecting channels.

11. The fuel cell system of claim 6, wherein the second mixer has tube-shaped spiral channels or intersecting channels.

12. A direct methanol type fuel cell system, comprising:
a fuel cell stack including at least one cell having an anode, a cathode and an electrolyte separating the anode and the cathode, wherein the at least one cell is configured to generate electricity through an electrical chemical reaction of a fuel and an oxidizer;
a raw material tank configured to store a raw material fuel;
a first mixer configured to receive non-reaction fuel and water from the fuel cell stack and configured to receive the raw material fuel from the raw material tank;
a pump configured to transfer the raw material fuel and the non-reaction fuel and water from the first mixer to the fuel cell stack; and
a second mixer positioned between the pump and the fuel cell stack, the second mixer configured to mix the raw material fuel from the first mixer, the non-reaction fuel and water.

13. The fuel cell system of claim 12, further comprising at least one separator disposed between a plurality of cells to form a laminated assembly together with the plurality of cells.

14. The fuel cell system of claim 13, wherein the second mixer has tube-shaped spiral channels or intersecting channels.

15. The fuel cell system of claim 12, wherein the second mixer has tube-shaped spiral channels or intersecting channels.

16. A direct methanol type fuel cell stack, comprising:
a fuel cell having an anode, a cathode and an electrolyte separating the anode and the cathode; and
means for mixing fuel and water coupled to the anode of the cell, wherein the means for mixing is configured to supply a uniform concentration of fuel and water to the anode.

17. The fuel cell stack of claim 16, wherein the means for mixing comprises a tube-shaped spiral channel.

18. The fuel cell stack of claim 16, wherein the means for mixing comprises a plurality of intersecting channels.

19. The fuel cell stack of claim 16, wherein the means for mixing comprises an active mixer.

20. The fuel cell stack of claim 16, wherein the means for mixing comprises a chaotic mixer.
